(19) United States
(12) Patent Application Publication
(10) Pub. No.: US 2026/0142205 A1
(43) Pub. Date: May 21, 2026

(54) DIAGNOSTIC METHOD FOR DIAGNOSING A STATE OF AN ELECTROCHEMICAL CELL OF AN ELECTROCHEMICAL ENERGY CONVERTER

(71) Applicant: Robert Bosch GmbH, Stuttgart (DE)

(72) Inventors: Chen Jin, Stuttgart (DE); Christophe Gerling, Filderstadt (DE); Julian Ruepp, Stuttgart (DE); Michael Phrygus Nguegnou, Leonberg (DE); Stefan Nagel, Waiblingen (DE)

(21) Appl. No.: 19/113,651

(22) PCT Filed: Sep. 18, 2023
(86) PCT No.: PCT/EP2023/075553

§ 371 Date: Mar. 20, 2025

(30) Foreign Application Priority Data
Sep. 21, 2022 (DE) 10 2022 209 931.1

(51) Int. Cl. H01M 8/04537; C25B 15/02

(52) U.S. Cl. CPC H01M 8/04559; C25B 15/02; H01M 8/04589; H01M 8/04619

(57) ABSTRACT

The present invention relates to a diagnostic method (100) for diagnosing a state of an electrochemical cell (301) of an electrochemical energy converter (300), wherein the diagnostic method (100) comprises:
determining (101) a curve (201) of electrical properties of the electrochemical cell over time,
determining (103) analyzable data packets (205, 209),
aggregating (105) at least one region (207, 211) of respective analyzable data packets (205, 209) into an aggregated curve,
determining (107) a slope for at least one region of the aggregated curve,
assigning (109) a characteristic value to the slope according to a specified assignment scheme in order to quantify a state of the electrochemical cell,
outputting (111) the characteristic value on an output unit,
   wherein an analyzable data packet (205, 209) comprises a plurality of data points whose values differ from one another by at most a specified threshold value for at least a specified duration.

### BACKGROUND

The present invention relates to a diagnostic method for diagnosing a state of an electrochemical cell of an electrochemical energy converter, a computing unit, and an electrochemical energy converter.

Fuel cells are electrochemical energy converters used, for example, to convert hydrogen and oxygen into water, electrical energy, and heat.

Porous electrodes of a fuel cell, mostly referred to as catalyst layers, typically consist of platinum particles applied to larger carbon particles. This carbon phase provides electron and heat transport. The carbon phase is also be permeated with ionomer to ensure proton conductivity.

Three-phase boundaries are required for an electrochemical reaction and result from the concurrence of platinum, ionomer and reactant.

A membrane is located in the center of a fuel cell and consists primarily of ionomer. It is the continuation of the ionomer phase of the electrodes. The function of this membrane is to transport hydrogen protons from the anode electrode to the cathode electrode with as little loss as possible, but also to separate both gas spaces from one another and to act as an electrical insulator. The proton conductivity of a membrane depends primarily on its temperature and water content.

Aging of these different components during fuel cell operation results in decreasing fuel cell power over time and thus needs to be monitored.

To monitor aging, it is known to measure a current polarization curve on the test bench, for example during maintenance, and compare it to a reference curve, perform cyclic voltammetry, perform Linear Sweep Voltammetry (LSV), and/or measure bleed-down times, and/or perform electrochemical impedance spectroscopy.

However, these methods are highly complex and time-consuming and cannot be performed online and continuously during normal operation.

### SUMMARY

In the context of the present invention, a diagnostic method, a computing unit, and chemical energy converters are presented. Further features and details of the invention arise from the respective dependent claims, the description, and the drawings. In this context, features and details described in connection with the diagnostic method according to the invention clearly also apply in connection with the computing unit according to the invention and the electrochemical energy converters, and respectively vice versa, so that mutual reference to the individual considerations of the invention always is or can be made with respect to the disclosure.

The present invention serves in particular to determine and quantify the state of at least one electrochemical cell of an electrochemical energy converter.

Therefore, according to a first aspect of the present invention, a diagnostic method for diagnosing the status of an electrochemical cell of an electrochemical energy converter is presented. The present diagnostic method comprises: determining a curve of electrical properties of the electrochemical cell over time, determining analyzable data packets, aggregating at least one region of respective analyzable data packets into an aggregated curve, determining a slope for at least one region of the aggregated curve, assigning a characteristic value to the slope according to a specified assignment scheme in order to quantify a state of the electrochemical cell, outputting the characteristic value on an output unit, wherein an analyzable data packet comprises a plurality of data points whose values differ from one another by at most a specified threshold value for at least a specified duration.

In the context of the present invention, an analyzable data packet refers to a number of measured values corresponding to a quasi-stationary state.

The present diagnostic method is based on the principle that measured values of an electrical property of a respective electrochemical cell determined by a sensor are evaluated, and only those measured values that are relevant or characteristic of the state of the electrochemical cell are used in order to diagnose its state. For this purpose, analyzable data packets are identified in the measured values, in particular data corresponding to a quasi-stationary state, and these data packets are aggregated into an aggregated curve. Consequently, data determined in non-stationary states, especially during a start-up phase or a standby phase, is discarded so that only data determined in a steady-state system state is used.

The specified duration provided according to the invention specifies a minimum time for which an electrochemical energy converter can settle into a respective state, minimizing the influence of external factors such as load and/or temperature changes while maximizing the signal response of electrical properties of the respective electrochemical cell.

Based on the aggregated curve of the analyzable data packets, a reliable statement about the state of the electrochemical cell can be made by determining a slope of the aggregated curve. For quantification, the slope is assigned a characteristic value, such as a numerical value on an ordinal scale or a color from a color scheme, in particular a traffic light scheme.

To ensure that the respective data of an analyzable data packet corresponds to a quasi-stationary state, i.e. determined during a quasi-stationary state of the electrochemical energy converter, an analyzable data packet comprises only data points whose values differ from one another by at most a specified threshold value for at least a specified duration.

Furthermore, it can be provided that an analyzable data packet comprises a region of a plurality of data points whose values differ from one another by at most a specified threshold value for at least a specified duration, wherein the region terminates at a late end of the analyzable data packet and is smaller than the analyzable data packet.

By selecting a region from a plurality of data points whose values differ from one another by at most a specified threshold value for at least a specified duration, in particular a late region after a specified duration of values that differ from one another by at most a specified threshold, an especially long oscillation of the state or the electrochemical energy converter is ensured, which minimizes influences from changing conditions, such as temperature changes or load changes, on the aggregated curve. Accordingly, the aggregated curve particularly validly depicts only a change in the electrical properties of the electrochemical cell.

It can be provided that the electrical properties comprise at least one parameter from the following list of parameters: current, voltage, power.

Because the parameters of current, voltage, and power of an electrochemical cell change with increasing age, they are particularly well-suited for determining the state of an electrochemical cell.

It can further be provided that the aggregated curve is extrapolated into the future, and the diagnostic method further comprises determining an additional slope for at least one region of the extrapolated curve, assigning an additional characteristic value to the additional slope according to a specified assignment scheme in order to quantify a future state of the electrochemical cell, and outputting the additional characteristic value on the output unit.

To predict a future state of an electrochemical cell and, for example, predict a decommissioning time or so-called “end-of-life,” the aggregated curve can be extrapolated. For this purpose, a straight line with the slope determined for the aggregated curve can be extended, for example, or a fitting function, such as the least-squares method or a polynomial fit, can be used in order to determine a future curve.

It can further be provided that, in order to determine whether an analyzable data packet comprises a plurality of data points whose values differ from one another by at most a specified threshold value for at least a specified duration, a variance and/or a derivative of the plurality of data points is calculated.

It can further be provided that the curve of electrical properties is filtered by means of a filter, so that only data points that satisfy a specified filter criterion are included in the curve, wherein the filter criterion stipulates that an operating temperature of the electrochemical energy converter is within a specified temperature range and/or a power of the electrochemical energy converter is not zero.

In particular, conditions in which the power output of an electrochemical energy converter is zero are not representative of the age of the respective electrochemical cells of the electrochemical energy converter, so that by filtering out these corresponding measured values, the validity of the remaining data for determining the age of the electrochemical cell is maximized.

According to a second aspect, the present invention relates to a computing unit for diagnosing the state of an electrochemical energy converter. The computing unit is configured so as to determine analyzable data packets from a path measured by a sensor of the electrochemical energy converter, aggregate at least a region of respective analyzable data packets into an aggregated path, determine a slope for at least a region of the aggregated path, assign a characteristic value to the slope according to a specified allocation scheme in order to quantify the state of the electrochemical cell, and output the characteristic value on an output unit, wherein an analyzable data packet comprises a plurality of data points whose values differ from one another by no more than a specified threshold value for at least a specified duration.

In the context of the present invention, a computing unit is understood to mean a computer, a server, a processor, a control device, or any other programmable circuit.

In particular, the present computing unit can be a central server communicatively connected to a plurality of electrochemical energy converters in order to perform the present diagnostic method, i.e. to receive measurements from respective electrochemical energy converters and determine a corresponding characteristic value. Accordingly, the determination of the characteristic value can be done online without a visit to a workshop.

Alternatively, the present computing unit can be part of a respective electrochemical energy converter, in particular part of a control unit.

According to a third aspect, the present invention relates to an electrochemical energy converter. The electrochemical energy converter comprises a number of electrochemical cells, a sensor configured so as to measure an electrical property of at least one electrochemical cell of the number of electrochemical cells, and a communication interface, wherein the communication interface is configured so as to transmit measured values determined by the sensor to a possible configuration of the present computing unit.

The communication interface of the electrochemical energy converter can be, for example, a wireless interface for communication having a central server or a cable for communication with a control unit.

According to a fourth aspect, the present invention relates to a further electrochemical energy converter. The further electrochemical energy converter comprises a number of electrochemical cells, a sensor configured so as to measure an electrical property of at least one electrochemical cell of the number of electrochemical cells, and a possible configuration of the present computing unit.

The further electrochemical energy converter is able to perform the present diagnostic method itself using its own, in particular local, computing unit.

It can be provided that the present electrochemical energy converter or the further electrochemical energy converter is an electrolyzer or a fuel cell system.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

Shown are:

FIG. 1 a possible embodiment of the diagnostic method present,

FIG. 2 a detailed illustration of the diagnostic method according to FIG. 1,

FIG. 3 a system having a possible configuration of the present electrolyzer and a possible configuration of the present computing unit,

### DETAILED DESCRIPTION

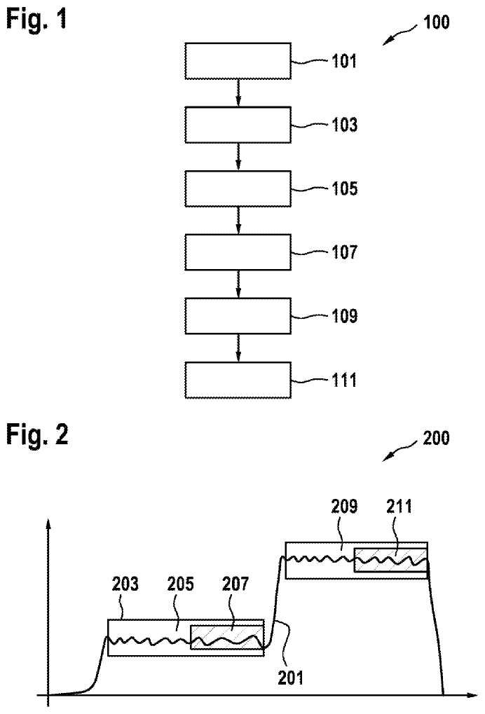

FIG. 1 shows a diagnostic method 100 for diagnosing a state of an electrochemical cell of an electrochemical energy converter. The diagnostic method 100 comprises a determination step 101 in which a curve of electrical properties of the electrochemical cell over time is determined, e.g. by means of an electrical sensor.

Furthermore, the diagnostic method 100 comprises a determination step 103 in which analyzable data packets are determined in the curve determined in the determination step 101, and an aggregation step 105 in which at least domains of respective analyzable data packets determined in the determination step 103 are aggregated into an aggregated curve.

Furthermore, the diagnostic method 100 comprises a further determination step 107, in which a slope is determined for at least one region of the aggregated curve, an assignment step 109, in which a characteristic value is assigned to the slope according to a specified assignment scheme in order to quantify a state of the electrochemical cell, and an output step 111, in which the characteristic value is output on an output unit, such as a display and/or a speaker.

According to the diagnostic method 100, an analyzable data packet comprises a plurality of data points whose values differ from one another by at most a specified threshold value for at least a specified duration.

FIG. 2 shows a diagram 200 with time represented on the X-axis and current strength on the Y-axis. A curve 201 corresponds to current strength values measured by a sensor of an electrochemical energy converter for an electrochemical cell.

After a warm-up phase, the electrochemical energy converter, which in this example is a fuel cell system, is subjected to a load, whereupon the electrochemical energy converter adjusts to the load and transitions into a quasi-stationary state 203, in which the respective measured values differ from one another by at most a specified threshold value for at least a specified duration. Accordingly, the quasi-stationary state 203 forms an analyzable data packet 205.

Furthermore, FIG. 2 shows a region 207 of a plurality of data points whose values differ from one another by at most a specified threshold value for at least a specified duration. In this case, the region 207 corresponds to a portion of the analyzable data packet 205 and terminates at a late part of the analyzable data packet 205, wherein the length of the region 207 can be specified. Alternatively, the region 207 can correspond to the length of the data packet 205. Accordingly, the measured values or data points of the region 207 were determined in a state where the electrochemical energy converter has been in the quasi-stationary state for a particularly long time and the variance of the measured values is particularly low.

Due to a further load change, the curve 201 jumps to another quasi-stationary state and forms a further analyzable data packet 209 with another region 211.

By aggregating the regions 207 and 211, an aggregated curve can be determined that only relates to electrical properties of the electrochemical cell in quasi-stationary regions and thus describes the aging of the electrochemical cell with particular validity.

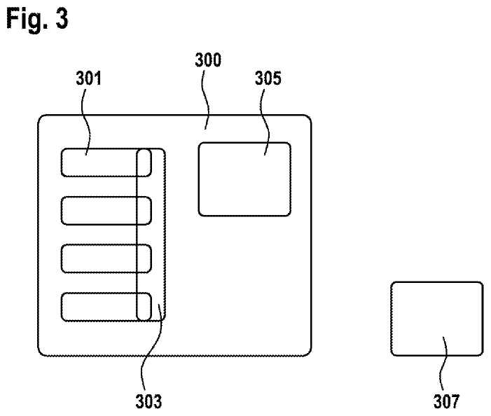

FIG. 3 shows an electrochemical energy converter 300. The electrochemical energy converter 300 comprises a number of electrochemical cells 301, a sensor 303 configured so as to measure an electrical property of at least one electrochemical cell 301 of the number of electrochemical cells 301, and a communication interface 305 configured so as to transmit measured values determined by the sensor 303 to a computing unit 307 in order to perform the diagnostic method 100 according to FIG. 1.

1. A diagnostic method (100) for diagnosing a state of an electrochemical cell (301) of an electrochemical energy converter (300),
wherein the diagnostic method (100) comprises:
determining (101) a curve (201) of electrical properties of the electrochemical cell over time,
determining (103) analyzable data packets (205, 209),
aggregating (105) at least one region (207, 211) of respective analyzable data packets (205, 209) into an aggregated curve,
determining (107) a slope for at least one region of the aggregated curve,
assigning (109) a characteristic value to the slope according to a specified assignment scheme to quantify a state of the electrochemical cell, and
outputting (111) the characteristic value on an output unit, wherein an analyzable data packet (205, 209) comprises a plurality of data points whose values differ from one another by at most a specified threshold value for at least a specified duration.

2. The diagnostic method (100) according to claim 1, wherein
an analyzable data packet (205, 209) comprises a region (207, 211) consisting of a plurality of data points whose values differ from one another by at most a specified threshold value for at least a specified duration, wherein the region (207, 211) terminates at a late end of the analyzable data packet (205, 209) and is smaller than the analyzable data packet (205, 209).

3. The diagnostic method (100) according to claim 1,
wherein
the electrical properties comprise at least one parameter from the following list of parameters: current, voltage, power.

4. The diagnostic method (100) according to claim 1,
wherein
the aggregated curve is extrapolated into the future, and the diagnostic method (100) further comprises:
determining a further slope for at least one region of the extrapolated curve,
assigning a further characteristic value to the further slope according to a specified assignment scheme to quantify a future state of the electrochemical cell,
outputting the characteristic value on an output unit.

5. The diagnostic method (100) according to claim 1,
wherein
to determine whether an analyzable data packet (205, 209) comprises a plurality of data points whose values differ from one another by at most a specified threshold value for at least a specified duration, a variance, and/or a derivative of the plurality of data points is calculated.

6. The diagnostic method (100) according to claim 1,
wherein
the curve of electrical properties is filtered by means of a filter, so that only data points that satisfy a specified filter criterion are included in the curve (201), wherein the filter criterion stipulates that an operating temperature of the electrochemical energy converter (300) is within a specified temperature range and/or a power of the electrochemical energy converter (300) is not zero.

7. A computing unit (307) for diagnosing a state of an electrochemical energy converter (300),
wherein the computing unit (307) is configured to
determine analyzable data packets (205, 209) from a curve (201) determined by a sensor (303) of the electrochemical energy converter (300),
aggregate at least one region (207, 211) of respective analyzable data packets (205, 209) into an aggregated curve,
determine a slope for at least one region of the aggregated curve,
associate the slope with a characteristic value according to a specified assignment scheme to quantify a state of the electrochemical cell (301), and
output the characteristic value on an output unit,
wherein an analyzable data packet (205, 209) comprises a plurality of data points whose values differ from one another by at most a specified threshold value for at least a specified duration.

8. An electrochemical energy converter (300),
wherein the electrochemical energy converter (300) comprises:
a number of electrochemical cells (301),
a sensor (303) configured to measure an electrical property of at least one electrochemical cell (301) of the number of electrochemical cells (301),
a communication interface (305),
wherein the communication interface (305) is configured to transmit measured values determined by the sensor (303) to a computing unit (307) according to claim 7.

9. An electrochemical energy converter (300),
wherein the electrochemical energy converter (300) comprises:
a number of electrochemical cells (301),
a sensor (303) configured to measure an electrical property of at least one electrochemical cell (301) of the number of electrochemical cells (301),
a computing unit (307) according to claim 7.

10. The electrochemical energy converter (300) according to claim 8,
wherein
the electrochemical energy converter (300) is an electrolyzer or a fuel cell system.
